(19) United States
(12) Patent Application Publication
(10) Pub. No.: US 2003/0030646 A1
(43) Pub. Date: Feb. 13, 2003

(54) Trilinear texture filtering method with proper texel selection

(76) Inventor: Kwo-woei Yeh, Tou Fen Chen (TW)

Correspondence Address: BIRCH STEWART KOLASCH & BIRCH, PO BOX 747, FALLS CHURCH, VA, 22040-0747, US

(21) Appl. No.: 09/925,448

(22) Filed: Aug. 10, 2001

(51) Int. Cl. G09G 5/00

(52) U.S. Cl. 345/582

(57) ABSTRACT

A trilinear texture filtering with proper texel selection is proposed to reduce the memory bandwidth and to eliminate blurring effect. The trilinear texture filtering method reads a pixel's information and calculates the pixel's size and the texture coordinates corresponding to a mipmap texture according to the pixel's information, such as vertex. The trilinear texture filtering method performs a bilinear texture filtering only in a higher resolution mipmap level to get a first color and performs a linear interpolation between the nearest texel color value of the lower resolution mipmap level and the first color to determine a final pixel color value in accordance with the LOD (level of detail) value. Because the invention selects texels more accurately than the typical trilinear texture filtering, the large amount of memory accesses are reduced and the image quality will not be sacrificed.

### BACKGROUND OF THE INVENTION

1. Field of the Invention

The present invention relates to a texture filtering method of computer graphic systems, and more particularly to a trilinear texture filtering method to achieve fast and cost-effective accessing by only selecting a pair of texels.

2. Description of the Related Art

In the processes of computer graphic systems, each pixel's color value has to be derived from texture by mapping, which is called texture filtering. In computer generated 3D images, texture filtering is a very important technique, Texture usually is a two-dimensional array of color values which are individually called texels. Each texel has its own address which is composed of a column and row numbers named S and T, respectively. Typically, each texel's texture coordinates (defined as “u” and “v”) are in the range of 0.0 to 1.0. The coordinates also represent the texel center corresponding to a texture coordinate according to the texture mapping. In 3D applications, the texture coordinates can be assigned to any vertex of any primitive. When the computer graphics system renders a primitive, texture coordinates are calculated and the corresponding texels are accessed from the memory for each pixel of the primitive. For instance, in 3D applications, an object that has a wood grain pattern can be created by mapping a wooden texture onto surfaces of the 3D object.

FIG. 1 is a texture processing in a computer graphic system, wherein the texture mapping data are stored in a texture storage device 10 such as a hard drive. When the rendering engine 12 requires the texture data for texture mapping, the texture is sent to the local memory 11 of the graphics accelerator through a system bus 13. Then, the rendering engine 12 reads the required texels from the local memory through the memory bus 14, and performs the texture-mapping processing. The existing texture-mapping methods include the nearest point sampling, bilinear texture filtering, and trilinear texture filtering.

FIG. 2 is a schematic illustration showing the texture filtering method of the conventional nearest point sampling. In this figure, the center of each texel is labeled as a circle, and the center of the pixel is labeled as “x”. Taking this figure as an example, the color of the pixel is set to be the color value of the nearest texel, i.e., the texel “b” enclosed by the bold lines. This texture filtering method is a low-cost method after computed. However, the method will cause undesired artifacts in the displayed image.

Next, FIG. 3 is a schematic illustration showing a conventional bilinear texture filtering method. As shown in the figure, the bilinear texture filtering method is performed by accessing four (up, down, left, and right) texels which are closest to the center of the pixel, and by computing an average value from the texels as the pixel's color value, using the distance as the weighted value, FIG. 4 is a schematic illustration showing a conventional trilinear texture filtering method (also called mipmap texture filtering). In the trilinear texture filtering method, the bilinear texture filtering is individually performed on the two nearest mipmaps. Then, the pixel's color value is determined by further processing the color obtained at each level according to the level of detail (LOD).

According to the above description, eight memory accesses are required for accessing a plurality of texels when the trilinear filtering is performed. Typically, a texture cache memory is used for reducing the memory bandwidth requirement for texture filtering in the 3D graphic system hardware. For the trilinear texture filtering, the cache memory must have eight output ports to provide texels for one pixel in one clock cycle. Unfortunately, the area of the cache memory increases with the number of the I/O ports and becomes unacceptable. The 3D graphics hardware can use multipass texture filtering to achieve the same effects, if desired texels cannot be obtained in one clock cycle. However, the performance of the graphics system will be sacrificed. It is therefore desirable to provide a texture filtering technique that eliminates graphics artifacts without large amounts of memory accesses.

Furthermore, according to the principle of mipmap, the mapping of the first level is calculated from the mapping of the previous level (the zeroth level). That is, the data of the first level's texel (a′) is generated from the data of the zeroth level's texels (a, b, c, d), while the data of the first level's texel (b′) is generated from the data of the zeroth level's texels (e, f, g, h), and so on. As shown in FIG. 4, when calculating the color of the first level using the bilinear filtering method, texels (a′, b′, c′, d′) are selected so that the calculated color of the first level is influenced. Therefore, although the trilinear texture filtering method can provide better color quality, blurring effects of the image may be caused in some cases.

### SUMMARY OF THE INVENTION

In view of the foregoing problems, an object of the present invention is to provide a cost-effective trilinear texture filtering method which reduces the texel accesses from texture memory in a computer graphic system.

To achieve the above-mentioned object, the trilinear texture filtering method of the invention includes the steps of:

accessing a pixel data;

calculating the pixel size and coordinates, in which the texture coordinates of the pixel corresponding to a mipmap are calculated according to the pixel data, the texture coordinates having an integral portion and a fractional portion;

selecting two mipmaps, in which a high-resolution mipmap and a low-resolution mipmap, whose texel sizes are closest to the pixel size, are selected according to the pixel size;

calculating the level of detail, in which the distance from the pixel to the high-resolution mipmap is calculated according to the pixel size;

selecting a primary texel, in which four texels closest to the pixel coordinates are selected from the high-resolution mipmap as a primary texel;

calculating a primary color, in which the pixel's color corresponding to the high-resolution mipmap is calculated as a primary color according to the primary texel and the fractional portion of the pixel's coordinates;

selecting an auxiliary texel, in which a texel closest to the pixel's coordinates is selected from the low-resolution mipmap as an auxiliary texel; and

calculating the pixel's color, in which the pixel's mapping color is calculated according to the primary color and the color of the auxiliary texel and using the pixel's level of detail corresponding to each mipmap.

### BRIEF DESCRIPTION OF THE DRAWINGS

FIG. 1 is a block diagram of a texture processing system.

FIG. 2 is a schematic illustration showing a conventional nearest point sampling method.

FIG. 3 is a schematic illustration showing a conventional bilinear filtering method.

FIG. 4 is a schematic illustration showing a conventional trilinear filtering method.

FIG. 5 is a flow chart showing the trilinear filtering method in accordance with a first embodiment of the invention.

FIG. 6 is a flow chart showing the trilinear filtering method in accordance with a second embodiment of the invention.

FIG. 7 shows the area in which the integral values of the texture coordinates of the pixels are even numbers or odd numbers at the same time.

FIG. 8 is a flow chart showing the trilinear filtering method in accordance with a third embodiment of the invention.

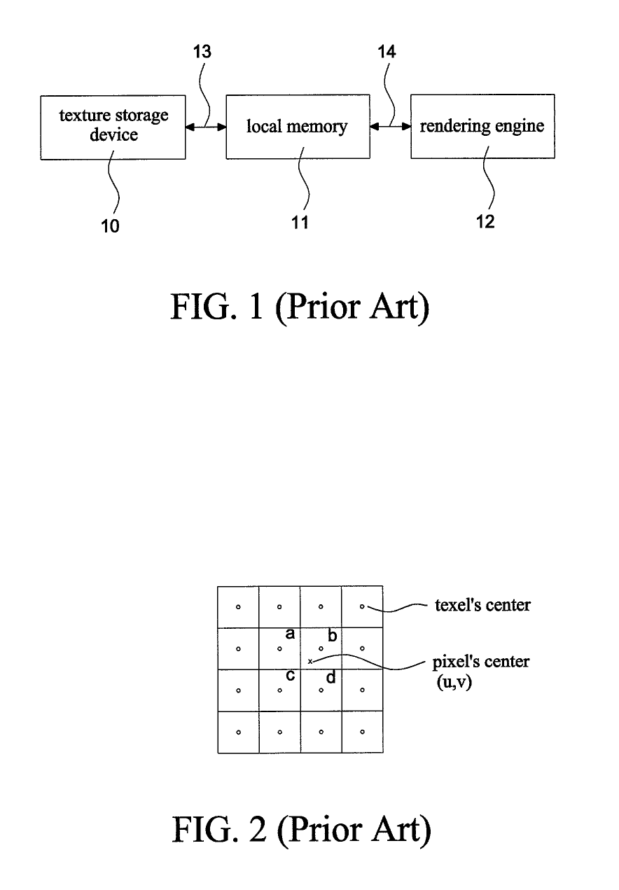

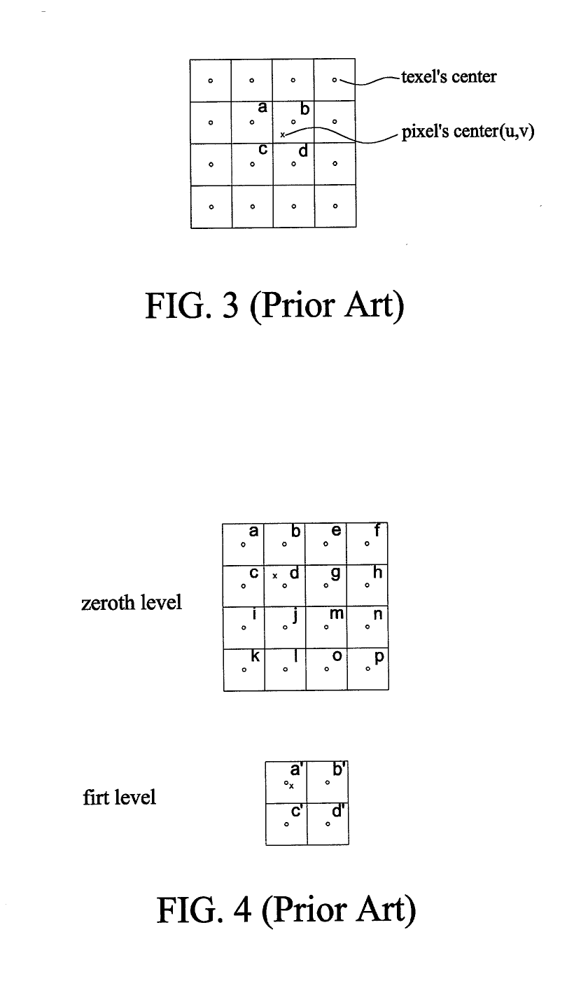

### DETAIL DESCRIPTION OF THE INVENTION

The trilinear texture filtering method of the invention will be described with reference to the drawings. In a typical trilinear texture filtering method, the colors of two mipmap levels are calculated by the bilinear filtering method, respectively. Then, the final colors are calculated according to the distance between the pixel and the level. Thus, the data of eight texels have to be read, and complicated calculations are required at the same time. Because the color of the low-resolution mipmap is calculated from the color of the high-resolution mipmap, blurring effects are included. Thus, the data of the low-resolution mipmap may not be required in some cases. The invention utilizes the positions at which the pixels on the high-resolution mipmap located, and the relative distances from the pixels to the level to calculate the colors of the pixels in many ways. The accessing time can be reduced, and the blurring effects also can be avoided.

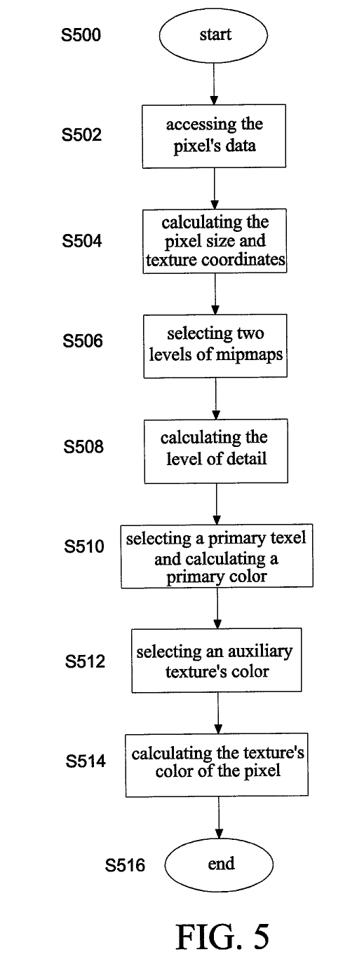

FIG. 5 is a flow chart showing the trilinear texture filtering method according to the first embodiment of the invention. In the trilinear texture filtering method of the invention, the features of the mipmap are also utilized. Specifically, two mipmap levels are selected according to the size of the delineation pixel, wherein the pixel's color corresponding to the high-resolution or low-resolution level is calculated according to the bilinear filtering method. Then, the final color of the pixel is further calculated using the data of one texel of the low-resolution level and the level of detail. The method of the invention is described in the following with reference to FIG. 5.

Step S500: start.

Step S502: accessing the data of the delineation pixel, the data including the pixel's coordinates (u, v) corresponding to the texture.

Step S504: calculating the pixel size and texture coordinates (S, T) of the delineation pixel, the texture coordinates (S, T) including an integral value and a fractional value.

Step S506: selecting two levels, which are closest to the pixel size and includes a high-resolution level and a low-resolution level, from the mipmap.

Step S508: calculating the level of detail (LOD) of the pixel corresponding to the high-resolution level according to the pixel size, wherein the smaller the level of detail, the closer to the high-resolution level.

Step S510: selecting four texels closest to the texture coordinates from the mapping of the high-resolution level, and calculating the representing color of the pixel in the level as a primary color by the bilinear filtering method.

Step S512: selecting a texel closest to the texture coordinates, from the mapping of the low-resolution level, as an auxiliary color.

Step S514: calculating the pixel's color by an interpolation method according to the primary color and the auxiliary color and using the level of detail as the weighted value.

Step S516: end.

Consequently, according to the method shown in FIG. 5, the trilinear texture filtering method of the invention only selects four texels from the mapping of the high-resolution level and one texel from the mapping of the low-resolution level, in order to calculate the pixel's color. Thus, the accessing of the texels can be reduced, and the operation time can also be decreased. Furthermore, the unrelated influence by the low-resolution level can be avoided, and thus, no blurring effects are caused.

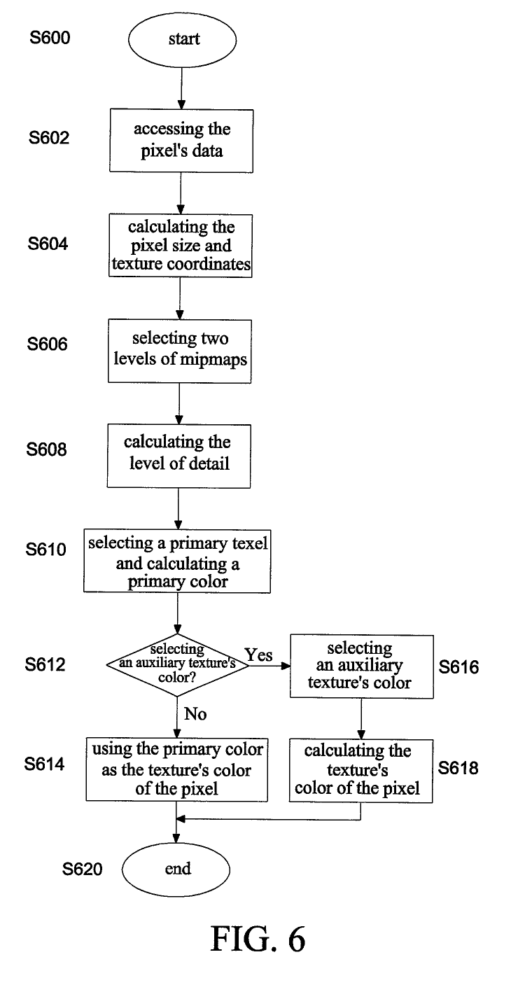

FIG. 6 is a flow chart showing the trilinear texture filtering method in accordance with the second embodiment of the invention. The method of this embodiment is substantially the same as that of the first embodiment, except for one different aspect. In this embodiment, the aspect is that only one texel of the mapping of the low-resolution level is selected when the integral values of the texture coordinates of the pixel are not even numbers or odd numbers at the same time. On the other hand, when the integral values of the texture coordinates of the pixel are even numbers or odd numbers at the same time, the pixel's color corresponding to the mapping of the high-resolution level is calculated as the final color by only the bilinear filtering method. That is, in step S612, it is determined whether to select the auxiliary color or not according to the integral values of the texture coordinates. If the auxiliary color is not selected, the process is jumped to step S614 and the primary color is used as the final color of the pixel. If the auxiliary color is selected, the following steps are the same as those of the first embodiment.

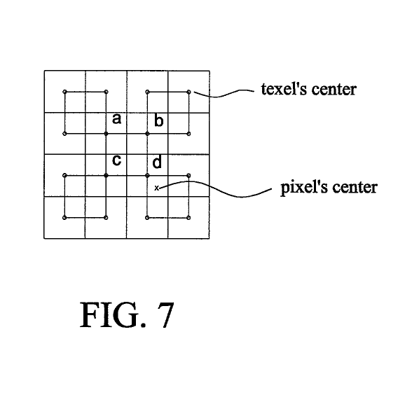

The areas enclosed by bold lines in FIG. 7 are the areas of the pixels whose texture coordinates are integral values or odd numbers at the same time. As shown in this figure, when the center of the pixel is located within the bold frames, four texels around the frame can reflect the color of the pixel. Also, the auxiliary color of the low-resolution level is generated from the four texels. Thus, it is not necessary to refer to the auxiliary color. As a result, when the integral values of the texture coordinates of the pixel are even numbers or odd numbers at the same time, it is only needed to calculate the pixel's primary color corresponding to the mapping of the high-resolution level by the bilinear filtering method. The accessing of the texels can thus be reduced, and the operation time can also be decreased.

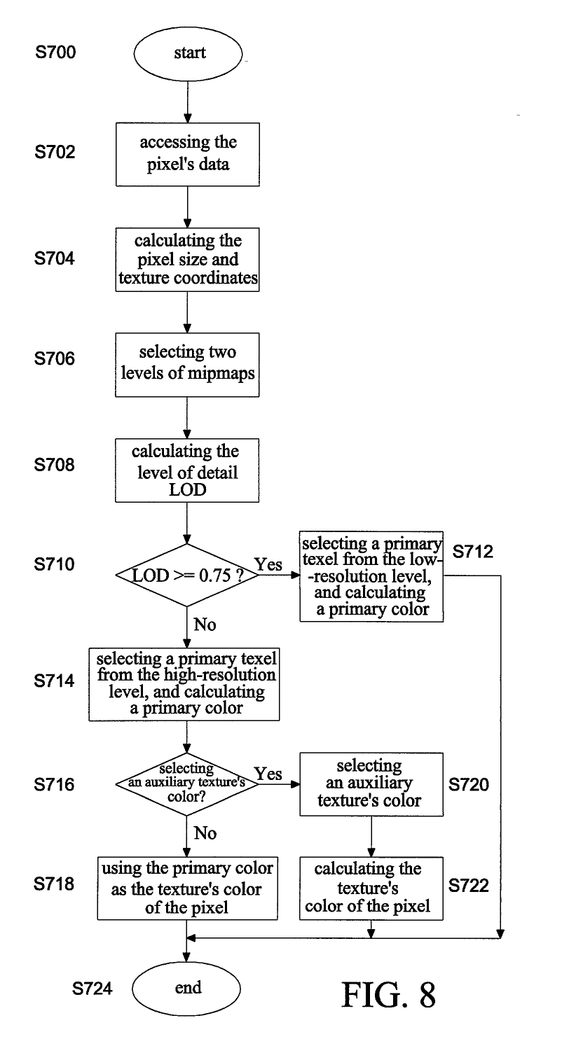

FIG. 8 is a flow chart showing the trilinear texture filtering method in accordance with the third embodiment of the invention. The method of this embodiment is substantially the same as that of the second embodiment, except for one different aspect. The aspect is that the embodiment decides to use the high-resolution level or low-resolution level, or to use the flow of the second embodiment according to the range of the level of detail. That is, in step S710, it is judged whether the level of detail is greater than a first threshold value (0.75 in this embodiment) or not. If the level of detail is greater than the first threshold value, the representation color of the pixel in the mapping of the low-resolution level is calculated by the bilinear filtering method in step S712. If the level of detail is not greater than the first threshold value, the representation color of the pixel in the high-resolution level is calculated by the bilinear filtering method in step S714. Then, in step S716, it is judged that whether the level of detail is smaller than a second threshold value (0.25 in this embodiment) or not, or it is judged that whether the integral values of the texture coordinates of the pixel is even numbers or odd numbers at the same time or not. If the level of detail is smaller than the second threshold value, or if the integral values of the texture coordinates of the pixel is even numbers or odd numbers at the same time, the process is jumped to step S718, and the primary color is used as the final color of the pixel. If the level of detail is not smaller than the second threshold value, and if the integral values of the texture coordinates of the pixel is not even numbers or odd numbers at the same time, the process is jumped to step S720 to select the auxiliary color. The following steps are the same as those in the first embodiment.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A trilinear texture filtering method comprising the steps of: accessing a pixel data;
calculating the pixel size and coordinates, in which the texture coordinates of the pixel corresponding to a mipmap are calculated according to the pixel data, the texture coordinates having an integral portion and a fractional portion;
selecting two mipmaps, in which an high-resolution mipmap and a low-resolution mipmap, whose texel sizes are closest to the pixel size, are selected according to the pixel size;
calculating the level of detail, in which the distance from the pixel to the high-resolution mipmap is calculated according to the pixel size;
selecting a primary texel, in which four texels closest to the pixel coordinates are selected from the high-resolution mipmap as a primary texel;
calculating a primary color, in which the pixel's color corresponding to the high-resolution mipmap is calculated as a primary color according to the primary texel and the fractional portion of the pixel's coordinates;
selecting an auxiliary texel, in which a texel closest to the pixel's coordinates is selected from the low-resolution mipmap as an auxiliary texel; and
calculating the pixel's color, in which the pixel's mapping color is calculated according to the primary color and the color of the auxiliary texel and using the pixel's level of detail corresponding to each mipmap.

2. A trilinear texture filtering method comprising the steps of:
accessing a pixel data;
calculating the pixel size and coordinates, in which the texture coordinates of the pixel corresponding to a mipmap are calculated according to the pixel data, the texture coordinates having an integral portion and a fractional portion;
selecting two mipmaps, in which an high-resolution mipmap and a low-resolution mipmap, whose texel sizes are closest to the pixel size, are selected according to the pixel size;
calculating the level of detail, in which the distance from the pixel to the high-resolution mipmap is calculated according to the pixel size;
selecting a primary texel, in which four texels closest to the pixel coordinates are selected from the high-resolution mipmap as a primary texel;
calculating a primary color, in which the pixel's color corresponding to the high-resolution mipmap is calculated as a primary color according to the primary texel and the fractional portion of the pixel's coordinates;
selecting an auxiliary texel, in which when the integral portion of the pixel's coordinates are not odd numbers or even numbers at the same time, a texel closest to the pixel's coordinates from the low-resolution mipmap is selected as an auxiliary texel;
calculating the pixel's color, in which when only the primary texel is selected, the primary color is used as the pixel's mapping color, and when the auxiliary texel is selected, the pixel's mapping color is calculated according to the primary color and the color of the auxiliary texel and using the pixel's level of detail corresponding the each mipmap.

3. A trilinear texture filtering method comprising the steps of:
accessing a pixel data;
calculating the pixel size and coordinates, in which the texture coordinates of the pixel corresponding to a mipmap are calculated according to the pixel data, the texture coordinates having an integral portion and a fractional portion;
selecting two mipmaps, in which an high-resolution mipmap and a low-resolution mipmap, whose texel sizes are closest to the pixel size, are selected according to the pixel size;
calculating the level of detail, in which the distance from the pixel to the high-resolution mipmap is calculated according to the pixel size;
selecting a primary texel from the high-resolution mipmap, in which when the level of detail is smaller than a first threshold value, four texels closest to the pixel's coordinates are selected from the high-resolution mipmap as a primary texel, and the pixel's color in the high-resolution mipmap is calculated as a primary color according to the primary texel and the fractional portions of the pixel's coordinates;
selecting a primary texel from the low-resolution mipmap, in which when the level of detail is greater than the first threshold value, four texels closest to the pixel's coordinates are selected from the low-resolution mipmap as a primary texel, and the pixel's color in the low-resolution mipmap is calculated as a primary color according to the primary texel and the fraction portions of the pixel's coordinates;
selecting an auxiliary texel, in which when the integral portions of the pixel coordinates are not odd number or even numbers at the same time and when the level of detail is between the first threshold value and a second threshold value, a texel closest to the pixel's coordinates are selected from the low-resolution mipmap as an auxiliary texel; and
calculating the pixel's color, in which when only the primary texel is selected, the primary color is used as the pixel's mapping color, and when the auxiliary texel is selected, the pixel's mapping color is calculated according to the primary color and the color of the auxiliary texel and using the pixel's level of detail corresponding to each mipmap.

4. The trilinear texture filtering method according to claim 3, wherein the first threshold value is 0.75.

5. The trilinear texture filtering method according to claim 4, wherein the second threshold value is 0.25.
